(19) United States
(12) Patent Application Publication
(10) Pub. No.: US 2023/0202737 A1
(43) Pub. Date: Jun. 29, 2023

(54) AN ACTIVE MULTILAYER POLYMER PACKAGE HAVING AN INTERNAL POLYMER COATING COMPRISING MUSTARD OIL, USEFUL FOR EXTENDING USEFUL LIFE OF CELIAC BAKERY PRODUCTS

(71) Applicant: UNIVERSIDAD DE SANTIAGO DE CHILE, Santiago (CL)

(72) Inventors: Ana Carolina LÓPEZ DE DISCASTILLO BERGAMO, Santiago (CL); María José GALOTTO LÓPEZ, Santiago (CL); Abel GUARDA MORAGA, Santiago (CL); Eliezer José VELÁSQUEZ, Santiago (CL); Simón RIVEROS FABA, Santiago (CL)

(21) Appl. No.: 17/996,395

(22) PCT Filed: Apr. 14, 2021
(86) PCT No.: PCT/CL2021/050028

§ 371 Date: Oct. 17, 2022

(30) Foreign Application Priority Data
Apr. 17, 2020 (CL) 1043-2020

(51) Int. Cl. B65D 81/28; B65B 25/16; B32B 27/32; B32B 27/30; B32B 27/08; A21D 15/08; A23L 3/3472

(52) U.S. Cl. CPC B65D 81/28; A21D 15/08; A23L 3/3472; B32B 27/08; B32B 27/32; B32B 27/306; B65B 25/16; B32B 2250/03; B32B 2250/40; B32B 2250/246; B32B 2255/10; B32B 2255/26; B32B 2307/54; B32B 2307/412; B32B 2307/732; B32B 2307/758; B32B 2307/7145; B32B 2307/7244; B32B 2307/7246; B32B 2439/70

(57) ABSTRACT

The present invention is related to packages to the food industry. Particularly, it is related to natural active packages for preserving bakery products against microorganism damage. More particularly, the invention is related to an antifungal active package comprising a multilayer polymer film with an internal polymer coating comprising mustard oil as natural essential oil having antifungal properties, useful for extending the half-life of celiac bakery products, preferably, a celiac bread.

### FIELD OF THE INVENTION

The present invention is related to packages to the food industry. Particularly, the invention is related to natural active packages for preserving bakery products against microorganism damage. More particularly, the invention is related to an antifungal active package comprising a multilayer polymer film having an internal polymer coating comprising mustard oil as natural volatile essential oil having antifungal properties, useful for extending the useful life of celiac bakery products, preferably, celiac bread.

### BACKGROUND

Active packages have mainly allowed maintaining the quality food products and extending its useful life by adding into the package compounds changing the internal environment (reducing oxygen and/or moisture quantity, among others) and/or direct antimicrobial agents, allowing a limited damage of the food properties, including nutritional value, aspect, taste, among others features, which are produced by certain microorganisms. These compounds are incorporated in coatings at the internal layer of a package, being in contact with a food, or the same are impregnated over such internal layer or the same are intercalated among layers of a package or they are immobilized in such internal layer of a package. Thus, these compounds can migrate from an internal layer of a package forward a food to reduce the microbial growth and extending the useful life of a food, or alternatively, without migrating, by being immobilized at the internal layer of a package, these compounds can be as well reducing the microbial growth inside of a package and prolongating the useful life of a food.

Today a general preference is using natural active compounds in detriment of synthetic chemical compounds to fulfill this labor of prolongating the useful life of a food. Preferably, natural volatile compounds coming from plants or extracts thereof are used, whose antimicrobial properties are well known, such as thymol, eugenol, cinnamaldehyde, carvacrol and menthol. However, the following considerations might be taken into account when these natural volatile active compounds are used: Many times high concentrations must be used to achieve a desired effectivity in reducing microorganisms, and having a volatile feature, the same can alter taste and/or odor of a food; they are chemically unstable and cannot be incorporated at the package; the same are specific antimicrobial properties, and thus, the same do not show an wide use spectrum; or microorganisms could show resistance to them.

On the other side, there are foods being elaborated to consumers having medical conditions limiting a free selection of foods such as persons suffering autoimmune diseases as a celiac disease. Generally, these foods having an upper value to standard/conventional foods of consumers without medical restrictions, and further the same are not available under a same ease way or volume than conventional foods, thus. its preservation along the time is a very desirable objective. This is even more desirable when a food product is celiac bread which shows a very early fungal damage.

There are patents related to developing antimicrobial active packages but that same are significantly different from the one of the present invention. For example, patent WO2015107089A1 (Inst. Tecnológico Del Embalaje Transporte y Logística Itene) describes materials having antimicrobial capability to food packaging formed by salecyl-aldehyde, carvacrol, thymol and combinations thereof. By a side, these active compounds are different to the active agents of the present invention, and further the actives from the above-mentioned WO publication are directed to be useful for extending the useful life of meats. By other side, “target” microorganisms or objective in the document under discussion are gran positive or gran negative bacteria as Pseudomonas aeruginosa and Staphylococcus aureus while the present invention is directed to reducing fungal incidence.

CN101711533A patent (State Agricultural Products FR) describes a use of mustard oil as preserving agent and its application on fruits and vegetables. In this development, 80-85% betacyclodextrin and 5-10% stearic acid are used to obtaining stearic acid a sustained release of this essential oil, and further the same is applied on packaging bags made of plastic paper of aluminum film.

Cozmuta and col. (2014) (“Active packaging system based on Ag/TiO₂ nanocomposite used for extending the shelf life of bread. Chemical and microbiological investigations”) publishing the development of a material for extending the useful life of bread based on a silver-titanium dioxide (Ag/TiO₂) nanocomposite. This development is directed to a white bread and is based on nanocomposites having a PEBD polymer matrix of AgTiO₂ nanoparticles obtained by a sol-gel method. The main differences of the present invention versus the development of Cozmuta and col. (2014), are: i) the present invention is directed to a type of special bread (elaborated with a flour different and without preserving agents) having a useful life shorter and more sensitive; ii) active agent is natural while the toxicity of metal nanoparticles is highly dependent of its morphology and side; iii) this published material is a monomaterial which highly probably has a high oxygen permeability while the present invention proposes a bilayer system formed in turn by a high oxygen-barrier coextruded substrate/film and a coating.

The article performed by Heras-Mozos and cols. (International Journal of Food Microbiology 2019, 290, 42-48. Development and optimization of antifungal packaging for sliced pan loaf based on garlic as active agent and bread aroma as aroma corrector. Heras-Mozos, R.; Muriel-Galet, V.; López-Carballo, G.; Catala, R.; Hernández-Muñoz, P.; Gavara, R.) uses anion essential oil to extend the useful life of bread, which was incorporated into a zeina matrix, a biodegradable polymer, by “casting” technique. As the present invention, an aroma corrector, in this case, to anion oil instead mustard oil. The main difference resides in the active compounds used, and in the use of zeina at lab scale instead of no commercial polymers as in the present invention. In the indicated publication, no adherence to the used surface was evaluated, which was made in the present invention as oppose.

RU2255884C1 (Ashraf Shaban Takha Bakr and others) is related to a material to packaging food comprising at least an external layer of polymer film comprising a polymer selected from Low pressure polyethylene (HDPE), an antiseptic selected from mustard seed essential oil, a fat plasticizer selected from a plasticizer mustard seed oil and a low pressure polyethylene, and additionally starch and hydroxyapatite in the following wt. percentage: 50-80% low pressure polyethylene; 0.5-5.0% mustard see essential oil; 7-30% mustard seed oil as softener; 2.5-6.0% starch; and 10-20% hydroxyapatite. Increasing the useful life of packaged products, giving bacteria and biodetriment protection.

KR101072883B1 (Industry Academic Cooperation Foundation, Yonsei University) is related to a coating antimicrobial composition comprising 1-5% volume binder (mustard oil), 1-3% volume mint and polyurethane having a average molecular weight between 5000 to 10,000, useful to coating per paper side or both paper sides, and can be located inside the food package with food as a paper strip form.

CN104910440A (Tongling Founder Plastics Technology CO LTD) is related to a full plastic film of an antibacterial starch mixture prepared from, by weight, 60-65 parts starch, 7-9 parts nano montmorillonite, 0.6-0.7 parts peanut oil, 1.2-1.4 parts tetra butyl titanate, 12-14 parts ramie fiber, 30-35 parts polyvinyl alcohol (PVA), 1-1.2 parts food grade white oil, 2.5-4 parts chitosan, 13-15 parts tributyl citrate, 2-3 parts mustard oil, 1-1.5 parts potassium sorbate, 2-2.5 parts stearic acid, and 3-5 parts kaolin. Starch is used as matrix and the same is mixed with PVA; and mustard oil is added due to its excellent antibacterial properties; citrate tributyl is added to reduce the PVA fusion point, and a film having improved processing and mechanical properties is obtained; this is safe and non-toxic and s proper to packaging or food preserving material and the same can be totally degraded at natural environmental after use.

CN102501508B (Xiamen Zhengxinghong ye Printing CO LTD) is related to an antibacterial film of 3 layers useful to preserving fresh food and vegetables and prolongates its quality along the time and at reduced cost, comprising an external layer of low density lineal polyethylene and low density polyethylene or degradable plastic, an intermediate layer of high density polyethylene, degradable plastic and lineal polyethylene and an internal layer of plastic having mustard oil and degradable plastic. Internal layer is firstly prepared, and then, the 3 layers are co-extruded, fixing temperature and velocity to a co-extrusion rotatory machine.

KR100755346B1 (Choi Moon Ho) is related to a film for maintaining fresh a food for long time, comprising forming an antimicrobial layer between 2 different other layers of a film. Antimicrobial layer is located between a PP (polypropylene) layer, 40 micrometers thickness, and other PP layer, 20 micrometers thickness, and the same is formed of a PP film, 40 micrometers, in whose upper side has a mixture having 10-50% wt natural antimicrobial diluted in 50-90% wt. Adhesive to mix 75-85% volume ethanol and 15-25% volume adhesive, wherein the adhesive is a mixture having 2 or more from starch, rosin, seaweed slime and polyurethane. Antimicrobial material is mustard oil, olive oil, sesame oil, sunflower oil, soja oil, camellia oil, corn oil, rapeseed oil, Beaver oil, cotton oil, peanut oil, cocoa oil, palm oil, fish oil, hardened oils, among others.

The present invention proposes an alternative to natural active package of special bakery products without the necessity of adding preserving agents to the product, and which are elaborated with flours other than wheat flour, and thus, the same require a particular package to extend its useful life, protecting the same against a fungal damage by limiting the growing of such microorganisms, into the product. Being such special bakery product, preferably, celiac bread.

### BREIF DESCRIPTION OF DRAWINGS

FIG. 1. Packaged celiac flax flour bread imagen.

FIG. 2. Breds in storing chambers at 20 ± 1° C.

FIG. 3. Breas in control and active packages after 5 stored days. FIG. 3A: Control -LDPE/EVOH/LDPE. FIG. 3B: Active - LDPE/EVOH/LDPE/A+MO.

### DETAILED DESCRIPTION OF THE INVENTION

The present invention is related to an antifungal active package allowing extending the useful life of celiac bread, essentially using flours without gluten and other than wheat flour used to traditional bread and avoiding the addition of preserving agents to bread. Active package comprising a high barrier co-extruded multilayer film comprising at least three polymer layers, this is, at least an external polymer layer, at least an intermediate polymer layer and at least an internal polymer layer, and further, at least a polymer coating to such at least one internal polymer layer being in contact with bread, carrying or incorporating a volatile essential oil having antifungal properties.

Preferably, such high barrier co-extruded film comprising a low-density polyethylene (PEBD) external polymer layer, an ethylene-polyvinyl alcohol (EVOH) intermediate polymer layer and a low density polyethylene (PEBD) internal polymer layer, and an acrylic coating to such internal polymer layer being in contact with bread carrying or incorporating mustard oil as natural volatile oil having antifungal properties.

Such high barrier co-extruded film comprising a low density polyethylene (PEBD) external polymer layer, an ethylene-vinyl alcohol (EVOH) copolymer intermediate polymer layer and a low density polyethylene (PEBD) internal polymer layer, and a poly (methyl methacrylate) coating such internal polymer layer being in contact with bread, carrying or incorporating mustard oil as volatile natural oil having antifungal properties.

It is known that mustard oil is a natural essential oil having a rich composition in components with high antifungal capability against predominant fungi in foods as are Aspergillus niger and Penicillum spp.

Optionally, such polymer coating can further comprise an antifungal volatile essential oil, an aroma masking agent, preferably, a bread aroma masking agent, which being incorporated reducing the possible sensorial impact of mustard oil on bread. Preferably, ratio antifungal essential oil to aroma agent is selected from a way to achieve limiting the fungal growing in bread without affecting its acceptance either by appearance and/or taste.

Such acrylic coating is added/incorporated to such internal polymer layer of such high barrier coextruded multiple film by a “coating” conventional technique. Preferably, such acrylic coating is added to such internal polymer layer of such high barrier coextruded multilayer film by “coating” printing by register so that the bread package, preferably, a bag preserving the sealing properties required to preserve bread and preserve the acceptance by the consumer side. Optionally, to confer a final feature to a package the same can use industrial casting by flexography or hollow recording.

Examples as detailed below have the objective of illustrating in a more detailed way how the present antifungal active package was prepared but without limiting the invention, providing some of the achieved results and which allowing a characterization of the present package by its mechanical, thermal, optical and barrier properties.

As mentioned above, the antifungal package of the present invention is specifically useful to bread manufactured with flours other than to wheat flour and without additives or preserving agents since the same are for consumers suffering celiac disease and/or gluten-type allergy. A higher cost of these breads impulse the necessity of preserving the same by a greater time, a then, the necessity of having packages with improved preserving properties is settled. In this way, it is important to note that the nutritional bread composition for celiac and/or gluten-type allergic consumer, contains no additives and the same are regularly merely packaged, using material having a high barrier under a modified environment system and many times with the incorporation of little bags or oxygen absorber “sachets”.

### Example 1: Characterization of Bakery Products and Its Conventional Commercial Packaging - Physicochemical Properties of the Product in a Conventional Packaging System

To a texture analysis of sample (commercial bread) the following properties were determined: hardness, gummyness, chewability and cohesivity as norm AACC (1995) 74-09 (http://img67.chem17.com/1/20170312/636249351441623177119.pdf). This assay was performed using a Universal Machine to assays (Zwick/Roell, Germany), with a load cell of 500 N, a cylindrical compress cell of 25 mm, using a software to data analysis. Further, a crumb color and bread crust were determined by a colorimeter CR - 410 (Konica/Minolta®, Japan), the measuring system was expressed in luminosity L* (0 to 100; light to dark), a* and b* indicating a color orientation (a*: color range, red to green; b*: color range, yellow to blue). To pH determination a pHmeter Hanna Edge was used, previously being calibrated using a buffer between 4.0 and 10.0. All the measurements were performed by triplicate. Moisture determination in samples was performed according to Chilean Norm NCh 841-78 (NCh 841.Of 78 “Foods-Moisture Determination”. Instituto Nacional de Normalización, INN, Chile: https://www.inn.cl/inn-informa-nuevas-normas-chilenas) being used a gravimetric method.

TABLE 1

Celiac bread characterization

| Analysis | Measurement (units) | Values |
|---|---|---|
| Bread grammage (g) | weight (g) | 599.1 ± 0.8 |
| Bread moisture (%) | moisture (%) | 54.38 ± 0.19 |
| Water activity | aW | 0.983 ± 0.004 |
| Bread pH | pH | 7.04 ± 0.13 |
| Texture profile (TPA) | Hardness (g) | 656 ± 88 |
| | Gummyness (g) | 184 ± 48 |
| | Chewability (g) | 156 ± 51 |
| | Cohesivity | 0.28 ± 0.04 |
| Crust color | L* | 50.94 ± 0.63 |
| | a* | 5.86 ± 0.15 |
| | b* | 19.62 ± 0.51 |
| Crumb color | L* | 57.37 ± 0.84 |
| | a* | 3.16 ± 0.10 |
| | b* | 10.24 ± 0.28 |

The packaging system of this product consisting of a high barrier material, particularly, a tri-layer package: biaxially oriented polyamide (BOPA)/Polyethyelenterephthalate having a coating/layer of aluminum oxide as barrier (PET-AIOx)/low density polyethylene (LDPE) having a modified environment 100% N₂, and use of an oxygen absorber.

As showed below, the present antifungal package is able to substitute this commercial system by an active coating over a high barrier substrate/film.

### Example 2 Preparing an Antifungal Active Package of the Invention

### 2.1 Active Coating

### 2.1.1. Preparing an Active Emulsion: Polymer Dissolution-Essential Oil

Coating consisting of a methyl methacrylate polymer dissolution at a concentration of 0.2 g/mL in ethyl acetate. A medium molecular weight methyl methacrylate (M_{w} = 84000 Da) was used and a density of 119d6 kg/m³, which is allowed to food contact as regulation 175.300 “Resinous and Polymeric Coatings”, Food and Drug Administration (FDA), USA, (https://www.accessdata.fda.gov/scripts/cdrh/cfdocs/cfcfr/CFRSearch.cfm?fr=175.300). A solution was prepared by a slow addition of methyl methacrylate polymer in an ethyl acetate volume at room temperature and under constant stirring to avoid the formation of agglomerates up to obtaining a homogeneous solution. Stirring time was 3 hours. Then, mustard oil (MO) was added at 6% wt based on the methyl methacrylate polymer under stirring with the help of a micropipette. Mustard oil used is an active substance with high antifungal capability having an specific gravity between 1.010-1.030 at 20° C. and a composition of (isothiocyanates + thiocyanates) > 97% and allyl isothiocyanate > 95%. The resulting solution of polymer/oil in ethyl acetate was homogeneous.

Brookfield viscosity of polymer solution with and without mustard oil was measured in a viscosimeter DV2T at 20° C. and a deformation velocity of 79.2 s⁻¹. A spindle SC4-18 was used, a SSA adapter and a sample volume of 6.7 mL in a container SC4-13RP. The viscosity of the polymer solution was 47.7 cP while the addition of mustard oil at 6% wt caused a reduction of viscosity of a coating varnish selected up to 35.6 cP in the present invention.

### 2.1.2. Coating Application

A polymer dissolution having an antifungal active agent (volatile essential oil, mustard oil) is applied on a tri-layer film constituted by two low density polyethylene (LDPE) layers and an intermediate layer of ethylene and vinyl alcohol copolymer (EVOH). This tri-layer material is an oxygen and water steam barrier. Coating, after dried at room temperature, resulting in a thickness between 3 to 4 µm. To a greater easy reading of this description, onwards, the film obtained is arbitrarily denominated “LDPE/EVOH/LDPE/A+MO” film.

### 2.2. Active Material Characterization

### 2.2.1. Thermal Properties

To the thermal properties study (Table 2) melting temperature (Tm) was recorded by a screening differential calorimetric analysis (DSC). After, a thermogravimetric analysis was performed using the same procedures described in the examples above.

TABLE 2

Thermal Properties film as proposed to the special bread active package

| Sample | DSC | | DTG* | |
|---|---|---|---|---|
| | Peak 1 (°C) | Peak 2 (°C) | Peak 1 (°C) | Peak 2 (°C) |
| LDPE/EVOH/LDPE/A+MO | 117.50 | 157.17 | 399.44 | 481.73 |

* thermogravimetric derivatives (DTG)

### 2.2.2. Mechanical Properties - Traction Assay

Traction-deformation assays was made in order to obtain parameters as Young module, tensile strength and rupture elongation. These analyses were made at room temperature in an universal machine to Zwick Roell assays (model BDO-FB 0.5 TH, Ulm, Germany) having a separation grab velocity of 500 mm/min according to norm ASTM D882-18 (https://www.astm.org/Standards/D882). Dimensions of probes were 2.5 cm × 16.5 cm having an effective distance between grabs of 50 mm. Preload was 0.1 MPa having an initial preload velocity of 10 mm/mm.min. Before the analysis, probes were conditioned at 23° C. ± 2° C. by a period of 48 h in a desiccator having a relative moisture of 50% ± 10%, as Procedure A of ASTM D618 practice (https://www.astm.org/Standards/D618.htm). Mechanical parameters were obtained by a software TestXpertvl 102 standard (Zwick/Roell) and was reported as an average of 10 replicates.

TABLE 3

Mechanical properties of control film and active material

| Film | Thickness (µm) | Grammage (g/m2) | Young Module (MPa) | Tensile strength (MPa) | Rupture deformation (%) |
|---|---|---|---|---|---|
| LDPE/EVOH/LDPE | 61 ± 2 | 57 ± 1 | 355 ± 47 | 19 ± 2 | 385 ± 74 |
| LDPE/EVOH/LDPE/A+MO | 64 ± 2 | 62 ± 1 | 275 ± 91 | 19 ± 3 | 429 ± 76 |

Table 3 shows mechanical parameters of a coating film having antifungal agent (A+MO) and control material (tri-layer film without mustard oil). An acrylic coating having active agent was observed was not affect the tensile strength of the film while there is a trend to improve ductility and reducing rigidity.

### 2.2.3. Optical Properties Characterization

Also a possible color change was evaluated after applied the coating (A) having an active agent (MO) by a colorimeter model Konica minolta CR-410. From CIELAB coordenates http://sensing.konicaminolta.com.mx/2014/09/entendiendo-el-espacio-de-color-cie-lab/) L* corresponding to luminosity (black (0) - white (100)), a* (red (+) - green (-)) and b* (yellow (+) -blue (-)) were measured.

Table 7 shows color coordinates L*, a*, b*, with non-coating materials, coating material (A) and with active coating (A+MO). Values L* give an idea of a high transparence of materials while low values a* and b*, near to zero and very similar to white are indicative of practically uncolored materials.

TABLE 4

Results of colorimetric coordinates of control film and the developed films

| Material | L* | a* | b* | ΔE* |
|---|---|---|---|---|
| LDPE/EVOH/LDPE | 98.35 ± 0.14 | -0.02 ± 0.02 | 2.10 ± 0.03 | |
| LDPE/EVOH/LDPE/A | 98.12 ± 0.16 | -0.03 ± 0.01 | 2.21 ± 0.05 | 0.27 |
| LDPE/EVOH/LDPE/A+MO | 98.26 ± 0.11 | -0.04 ± 0.01 | 2.17 ± 0.04 | 0.14 |

To observe results it is appreciated that parameters L*, a* and b* of active films do not significantly vary with respect to a control (LDPE/EVOH/LDPE). This is corroborated by a difference color parameter (ΔE*) stablishing a color variation related to control (LDPE). These values indicated an imperceptible color difference as ΔE* scale found in bibliography (Mohammadi, M.; Yousefi, A.A.; Ehsani, M. (2008) Characterizing films of polyethylene blends: an application of colorimetric parameters measurements. Progress in color, colorants and coating (PCCC) 8(3), 219-235; Cruz-Romero, M.; Kelly, A. L.; Kerry, J. P. (2007). Effects of high-pressure and heat treatments on physical and biochemical characteristics of oysters (Crassostrea gigas). Innovative Food Science & Emerging Technologies, 8(1), 30-38).

On the other hand, opacity was measured to the developed films determining an absorbance of 600 nm using a spectrophotometer. Results of this analysis are showed in Table 5. Opacity is understood as a transparence grade after passed radiation which depends on physical and chemical environment conditions, being this inversely proportional to transparence.

TABLE 5

Determination of Opacity film

| Samples | Thickness (mm) | Absorbance _{(600 nm)} | Opacity (nm/mm) |
|---|---|---|---|
| LDPE/EVOH/LDPE | 0.059 ± 0.002 | 0.103 ± 0.005 | 1.73 ± 0.11 |
| LDPE/EVOH/LDPE/A | 0.066 ± 0.001 | 0.086 ± 0.005 | 1.26 ± 0.08 |
| LDPE/EVOH/LDPE/A+MO | 0.064 ± 0.001 | 0.081 ± 0.004 | 1.30 ± 0.07 |

The obtained results to film opacity evidence that the incorporation of resin slightly affect the film transparence, however, the addition of an active agent (MO) does not produce any variation in this property in relation to control. However, the active film has a high transparence which allowing to observe a very well packaged product.

### 2.2.4. Barrier Property Characterization

Oxygen permeability of samples was determined as international norm ASTM D-3985 (https://www.astm.org/Standards/D3985.htm). Equipment used was OXTRAN® 2/20 MOCON. This equipment allows measuring of velocity to which oxygen through by the polymer material at a pressure of 760 mm Hg. Results of this analysis are showed in Table 6. Films coated with active agents (volatile essential oil/mustard oil) were not analyzed by a possible saturation of oxygen sensor in the equipment.

TABLE 6

Determination of oxygen permeability in materials at 23° C.

| Samples | Permeability (cc/m²·day) | Permeance (cc·mil/m²·day) |
|---|---|---|
| LDPE/EVOH/LDPE (control) | 0.81 ± 0.01 | 0.033 ± 0.002 |
| LDPE/EVOH/LDPE/A+MO | 0.22 ± 0.01 | 0.052 ± 0.001 |

Results as obtained shows that a coated material (A+MO) has a higher oxygen barrier than control material (LDPE). According to the data sheet the resin as used, this type of coating can increase the structure barrier to which is applied. Values as obtained to oxygen permeability ensures a good barrier limiting the oxygen presence during the storing. Control material is traditionally used to packaging bread. However, currently to special bread using a BOPA base, which have an intermediate permeability.

Examples show the efficiency of the present active antifungal package to preserve bakery products, celiac bread (without gluten), and without incorporation additives.

### Example 3: Useful Life of Bakery Product(s) Packaged with the Present Antifungal Active Package

### 3.1. Characterization of Physicochemical Properties of Product in a Packaging System

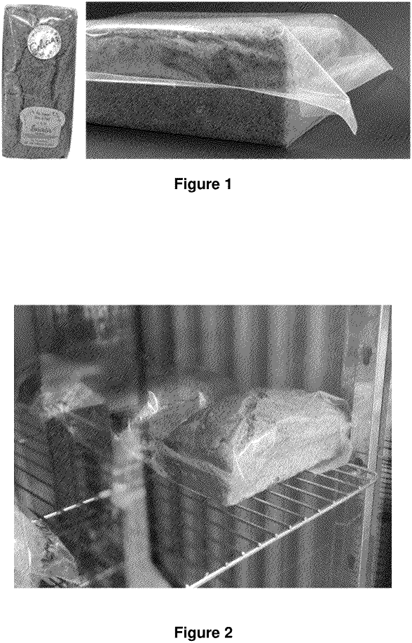

The selected commercial bread is constituted by linseed flour and a commercial package showed in FIG. 1. A physico-chemical characterization was performed determining the following parameters: moisture, water activity (aw), grammage, pH, color (ClELab) and texture (TPA). These results are showed in Table 7.

Mass of each product (grammage) is determined using a digital balance Shimadzy Aux120, weighting five samples and calculating its media.

Determination of moisture in samples was performed according to the Chilean Norm NCh 841-78 (NCh 841.Of 78 “Alimentos- Determinación de Humedad”, Instituto Nacional de Normalización, INN, Chile: https://www.inn.cl/inn-informa-nuevas-normas-chilenas) being used a gravimetric method.

Bread water activity was measured in an equipment AQUALAB® Series 3 TE (AQUALAB®, USA) under norm AOAC 978.19B (Official Methods of Analysis from the Association of Official Agricultural Chemists (AOAC) International, (2019) 21st Edition: https://www.aoac.org/official-methods-of-analysis-21st-edition-2019/).

Bread pH is measured as method AACC 02-52.01 (AACC Method 02-52.01 Hydrogen-Ion Activity (pH) -- Electrometric Method: https://methods.aaccnet.org/summaries/02-52-01.aspx). Constant stirring (Magnetic Agitator IKA® C-MAG HS7, Germany). pH-meter (Hanna Instruments® Edge, USA). A standard buffer was used to calibrate a pH-meter between 4.00 and 10.00 (Hanna Instruments®), measurements were performed by triplicate.

To the texture analysis is measured the texture properties (Hardness, Gummyness, chewability and Cohesivity) of commercial bread as norm AACC (1995) 74-09 (http://img67.chem17.com/1/20170312/636249351441623177119.pdf). Assay universal machine (Zwick/Roell, Germany), loading cell 500 N, cylindrical compression cell 25 mm, together with a testXpert® II software of data analysis (Zwick, Germany). Further, to the texture analysis of commercial bread the following properties were determined: hardness, gummyness, chewability and cohesivity as norm AACC (1995) 74-09 (http://imq67.chem17.com/1/20170312/ 636249351441623177119.pdf). assay was made in an assay universal machine (Zwick/Roell, Germany), with a loading cell 500 N, cylindrical compression cell 25 mm, using testXpert® II software of data analysis (Zwick, Germany).

Finally, color of crumb and crust of breads were determined (by triplicate) by a colorimeter CR -410 (Konica/Minolta®, Japan), a measure system expressing luminosity L* (light or dark), a* and b* stating the color orientation (a*: range of red color - green; b*: range of yellow-blue color).

TABLE 7

Characterization of commercial celiac bread

| Analysis | Measurement (units) | Values |
|---|---|---|
| Bread Grammage (g) | weight (g) | 599.1 ± 0.8 |
| Bread moisture (%) | Moisture (%) | 54.38 ± 0.19 |
| Water activity | Aw | 0.983 ± 0.004 |
| Bread pH | pH | 7.04 ± 0.13 |
| Texture profile (TPA) | Hardness (g) | 656 ± 88 |
| | Gummyness (g) | 184 ± 48 |
| | chewability (g) | 156 ± 51 |
| | Cohesivity | 0.28 ± 0.04 |
| Crust color | L* | 50.94 ± 0.63 |
| | a* | 5.86 ± 0.15 |
| | b* | 19.62 ± 0.51 |
| Crumb color | L* | 57.37 ± 0.84 |
| | a* | 3.16 ± 0.10 |
| | b* | 10.24 ± 0.28 |

### 3.2. Packaging System of Bakery Product(s) in Relation to Useful Microbiological Life

An in vitro antifungal capability study was carried out to LDPE/EVOH/LDPE/A + MO + aroma agent/masking aroma bags. Active concentration selected to the above in vitro assays was 6% wt mustard oil (MO) related to methyl methacrylate polymer, and 2% wt aroma masking agent (fresh bread aroma - Fresh Oven Bread) was added. To carry out the assay, bread without gluten and additive added was used. Thus, type of special bread is composed by: integral rice flour, linseed flour, potato starch, tapioca starch, corn starch, bakery powder, xanthan gum, yeast, sea salt and sunflower oil.

Samples were stored by 30 days at a constant temperature 20 ± 1° C. in a Hilab ARG X300E stove, a visual analysis was made to the superficial presence of fungus and samples were compared against controls (samples of LDPE/EVOH/LDPE film), as showed FIG. 2.

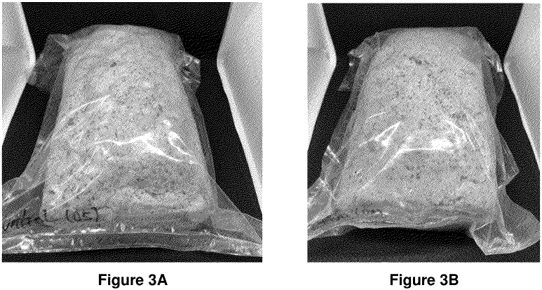

FIG. 3 shows packaged samples in a control package (LDPE/EVOH/LDPE) as well as in an active package (LDPE/EVOH/LDPE/A+MO) after 5 days of stored, where the presence and growing of these microorganisms (fungus) is due to an inherent initial microbiological load in the manufacturing bread process. A fungal growth can be observed present in the commercial bread having no additive after 5 days stored at 20 ± 1° C. A P. expansum and A. niger growth is identified among others typical xenophile fungus of post-baked contamination to this type of product process.

Samples of active packages were maintained for 30 days to know if fungal superficial growth is extended by more long time. However, it was observed that samples were kept without superficial fungus after this time. No greater time were tested since commercially this type of products are not allowable by a consumer by an evident sensorial detriment due to mainly to starch retro degradation (aging).

1. Antifungal active package for bakery products, preferably celiac bread comprising a co-extruded multilayer film having a high barrier comprising at least 3 polymer layers: at least an external polymer layer, at least an intermediate polymer layer and at least an internal polymer layer, and further, at least a polymer coating to such at least internal polymer layer carrying or incorporating a volatile essential oil having antifungal properties.

2. The antifungal active package of claim 1 wherein such external polymer layer is selected from a low-density polyethylene (PEBD) external polymer layer.

3. The antifungal active package of claim 1 wherein such intermediate polymer layer is selected from an ethylene-vinyl alcohol copolymer intermediate (EVOH) polymer layer.

4. The antifungal active package of claim 1 wherein such internal polymer layer is selected from a low-density polyethylene (PEBD) internal polymer layer.

5. The antifungal active package of claim 1 wherein such polymer coating is selected from an acrylic coating.

6. The antifungal active package of claim 5 wherein such acrylic coating is selected from a poly(methyl methacrylate) polymer coating.

7. The antifungal active package of claim 1 wherein such essential oil having antifungal properties is selected from mustard oil.

8. The antifungal active package of claim 1 comprising a high barrier co-extruded tri-layer film comprising an external polymer layer selected from a low-density polyethylene (PEBD) external polymer layer, an ethylene-vinyl alcohol copolymer intermediate (EVOH) polymer layer and a low-density polyethylene (PEBD) internal polymer layer, and further, at least a poly (methyl methacrylate) polymer coating to each internal polymer coating carrying or incorporating mustard oil.

9. The antifungal active package of claim 8 wherein such mustard oil is present in such poly (methyl methacrylate) polymer coating at a concentration of 6% wt based on the poly (methyl methacrylate) polymer coating weight.

10. The antifungal active package of claim 1 wherein such polymer coating further comprising an aroma masking agent.

11. The antifungal active package of claim 10 wherein such aroma masking agent is present in such poly (methyl methacrylate) polymer coating at a concentration of 2% wt based on the poly (methyl methacrylate) polymer coating weight.

12. The antifungal active package of claim 11 wherein such aroma masking agent is selected from bread aroma.

13. The antifungal active package of claim 1 wherein such acrylic coating is added/incorporated to such internal polymer layer of such high barrier co-extruded multilayer film by a conventional “coating” technique.
